(19) United States
(12) Patent Application Publication
(10) Pub. No.: US 2002/0072913 A1
(43) Pub. Date: Jun. 13, 2002

(54) Voice control and uploadable user control information

(76) Inventor: Paulus Wilhelmus Maria Ten Brink, Eindhoven (NL)

Correspondence Address: Corporate Patent Counsel, U.S. Philips Corporation, 580 White Plains Road, Tarrytown, NY, 10591, US

(21) Appl. No.: 09/944,302

(22) Filed: Aug. 31, 2001

(30) Foreign Application Priority Data
Sep. 7, 2000 (EP) 00203111.0

(51) Int. Cl. G10L 21/00; G10L 11/00

(52) U.S. Cl. 704/270

(57) ABSTRACT

A multi-device consumer electronics system is operated. The system has a first device with a first user interface including a voice control facility fed by voice pickup. A second device is functionally interconnected with the first device. In particular, the method executes:

interconnecting the first and second devices through a user control level interconnection;

loading speech recognition data relevant to a second user interface pertinent to the second device from the second device into the voice control of the first device;

recognizing by the voice control of one or more voice commands pertaining to the second user interface and forwarding associated recognition information to the second device;

operating the second device as governed by the associated recognition information.

### BACKGROUND OF THE INVENTION

The invention relates to a method for operating a multi-device consumer electronics system as claimed in the preamble of claim 1. Consumer electronics systems, although internally attaining a sophistication that until recently was reserved for professional systems like mainframe-based systems, industrial and medical automation systems, scientific computing and the like, must however present to a user person an interface that is both transparent and straightforward. A particular facility of such systems is voice control for devices such as video recorders, audio and TV sets, CD and DVD players, and the like. Various further types of applicable consumer electronic devices are those that can be used by inexperienced members of the general public and in non-professional environments such as domotics and security. Such devices could then encompass home environment control, kitchen and washroom appliances, cameras, and portable telephone devices. Now, inasmuch as the respective devices would need various idiosyncratic commands, in principle each thereof would need its own speech recognition facility. For cost saving, the speech recognition facility may be mapped on a particular master device among the various devices. Such measure however requires that the master would know all commands, etcetera, that should be recognized. Inasmuch as such commands would apply to all possible kinds of slave devices, such requirement would thus lead to a great degree of inflexibility. On the other hand, specific user programming of the master device is out of the question in view of the intended simplicity thereof. Note also that many systems don't have all of the possible kinds of slave devices, that new kinds or versions of slave devices may be designed afterwards, and that certain kinds of slave devices may occur in duplicate, such as audio tapes. Furthermore, slave devices may come from different manufacturers that could each specify their own recognition protocol; these should be usable as well. Note that the diminishing of the number of utterances that must be recognized, such as in a system with only relatively few slave devices, may improve the reliability of the overall speech recognition.

### SUMMARY TO THE INVENTION

In consequence, amongst other things, it is an object of the present invention to ensure a high degree of flexibility in providing a speech recognition facility in the master device without the need for user programming thereof.

Now therefore, according to one of its aspects the invention is characterized according to the characterizing part of claim 1. The loading of the speech recognition information into the master device is quite straightforward, and may be effected on various levels of sophistication, depending on the actual facilities offered by the master, and/or the functionality level intended for the system as a whole.

By itself, an information system with a speech interface has been described in U.S. Pat. No. 5,774,859, such indicating the applicable level of skill in speech recognition per se. The present invention however, provides a facility for dynamically loading into a master device of the speech recognition information that by itself pertains to speech recognition on behalf of a slave device.

The invention also relates to a multi-device system arranged for implementing the method as claimed in claim 4, and to a master device and to a slave device arranged for use in such system. Further advantageous aspects of the invention are recited in dependent claims. The speech recognition in the master device need not know beforehand the commands applicable to the slaves, inasmuch as speech recognition proper need not know the content of the speech, but only the association of a voice specification or “fingerprint” to a particular representation thereof. In consequence, the wording of a command, the language of the command, the gender of the speaker, and various other types of variations may be programmed in the master through initializing such by the slave device in question. Then, the recognizing may use a description of the speech signal to be recognized.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a consumer electronics system provided with first and second devices;

FIG. 2, an operational flow chart of the loading and operating phases of the system.

### DETAILED DESCRIPTION OF PREFERRED EMBODIMENTS

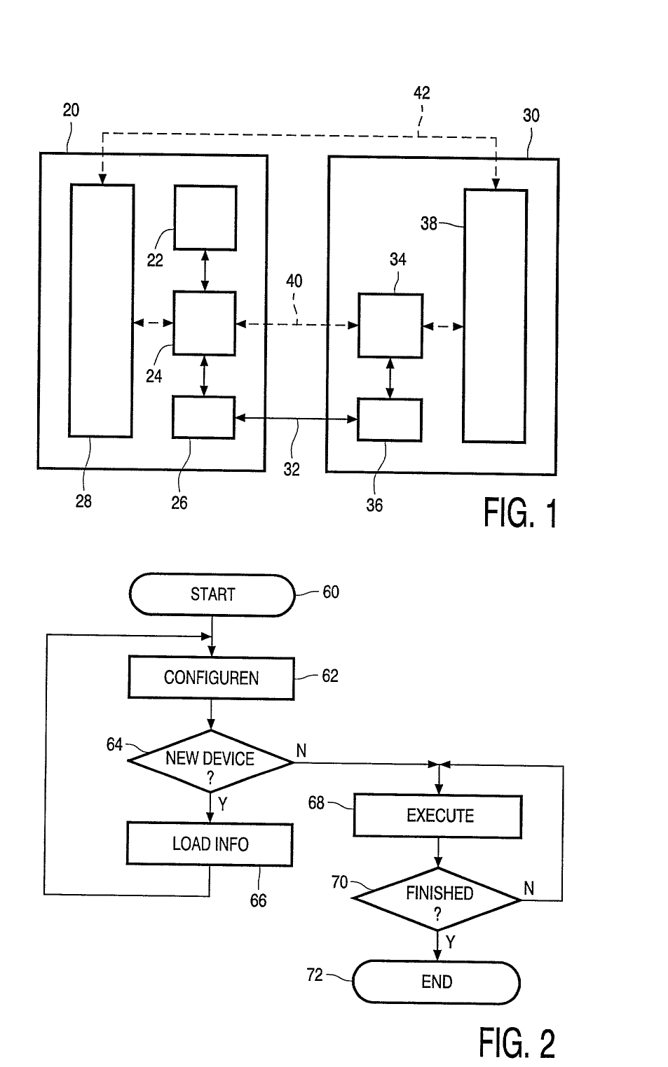

FIG. 1 illustrates a consumer electronics system provided with a first or master device 20 and a second or slave device 30. Multiple slave devices may be present. The first device may without implied or express limitation be a television set. The second device may without implied or express limitation be a video recorder. Device 20 has a user functionality 28 that may tune to broadcast TV signals or switch to a particular cable TV program facility, and display program items and other items on a television screen not shown in detail for brevity. Likewise, device 20 may present such items on line 42 for storage in video recorder 30. The operation of device 20 is governed by a central digital controller 24.

The digital controller 24 is connected to speech recognition controller 22 that can receive and recognize user commands and other utterances in speech and, as the case may be, may also output speech utterances to a user, such as questions, commands, or countersignalizations regarding earlier speech recognitions, or possibly, non-recognitions. Next to the speech channel, further control interaction may be executed through the screen, by text, hotspots, and the like, or by mechanical interaction such as keyboard and/or mouse.

The digital controller 24 controls the overall operation of device 20, in particular its prime facility 28, but the description thereof has been foregone here, inasmuch as such may be largely conventional. Furthermore, the digital controller 24 bidirectionally connects to bus interface controller 26 that is attached to bidirectional control bus or user level control bus 32.

Device 30 has a user functionality 38 that for the case of a VCR may store TV items that had been received in device 20 and/or output stored items for display by device 20, for which functions the bidirectional interconnecting line 42 will cater. The operation of device 30 is governed by a central digital controller 34. The device 30 has no counterpart subsystem that would correspond to speech recognition controller 22. Even if this counterpart were present, the application of the present invention could cause it to suppress its operation, although speech out might in principle continue. Various questions, commands, or countersignalizations regarding earlier speech recognitions as would be necessary, go to device 20 for outputting. Of course, device 30 may have its own signalization, such as through a text LED. The digital controller 34 in the first place controls the overall operation of device 30 in a manner that has been foregone for brevity. Furthermore, it is bidirectionally connected to the data bus interface controller 36, in its turn being attached to bidirectional control bus 32. Upon first attachment of device 30, controller 34 will transmit necessary items for speech recognition through channel 32 and bus controllers 26 and 36, to controller 24, to subsequently enable speech recognition controller 22 to adequately recognize such menu or other type of speech items that pertain to device 30, rather than to device 20. Of course, those speech items that pertain to the master device or an appropriate selection thereof may still be recognized as well.

The speech items sent to device 20 for recognition may pertain to elements of a selection menu, and/or may contain speech in the form of a phonetic description. Now, the two devices of the illustrated embodiment have been shown interconnected by three lines. Line 32 is used for transferring speech recognition information from device 30 to device 20. Line 42 is used to transfer data between device 20 and device 30, thereby representing the foremost utility of the system. Furthermore, line 40 interconnects the two controllers 24 and 34; this line may be virtual in that the physical transport occurs on user level control line 32. In principle, such may apply to line 42 as well. The interconnection facility 32 may be bus, star, or any applicable configuration, and the inventor presently prefers the HAVi interconnection protocol or context that is presently being proposed for all types of audio video interconnections.

The recognition protocol will signal a recognized or otherwise mapped speech item pertaining to device 30 to that device, for thereby governing its operation as appropriate. If applicable, the state of the recognition process may dynamically influence the spectrum of the recognizable speech items, such as for certain of the slave devices then having only the name thereof recognizable.

FIG. 2 illustrates an operational flow chart of the loading and operating phases of the system illustrated in FIG. 1. In block 60, the system is started, such as by power up, followed by in the master device ascertaining availability and claiming of the necessary hardware and software resources. In block 62, the system is configured in that all connected devices are called by the master. If insufficient resources are present, such as in that the VCR has been uncoupled since power off, this will be reported to the user; for simplicity, this feedback has not been shown in the Figure. In block 64, it is checked whether any new device is present that had not been reported earlier. If YES, in block 66 the necessary speech information is loaded from the new slave device into the master device. Thereupon, the configuring is resumed, until all new devices will have been registered. By itself, unregistering would be feasible as well. Alternatively, the registering could be a continally active background process that intermittently would poll all slave devices. Eventually, the exit NO from block 64 is asserted, whereupon the system proceeds to block 68. Therein, the principal program is executed. In block 70, the controller checks for a termination of the operation. As long as NO, the system cycles though block 68. If YES, the system goes to block 72, wherein the operation will be terminated.

Modifications will be apparent to persons skilled in the art such that they would remain inside the scope of the appended claims. By way of example, a newly attached slave device could take the initiative for the loading of the speech information as in block 66, such as according to a plug-and-play organization. The speech recognition shown here in device 20 may alternatively be effected in a remote device such as in a portable telephone that connects to one or more slave devices 30. In that case, the remote interconnection with the other consumer devices may even be effected by Internet.

1. A method for operating a multi-device consumer electronics system, that is provided with a first device having a first user interface including a voice control facility fed by voice pickup means, and a second device functionally interconnected with said first device,
said method being characterized by the following steps:
interconnecting said first and second devices through a user control level interconnection;
loading speech recognition data relevant to a second user interface pertinent to said second device, from said second device into the voice control facility of said first device;
recognizing by said voice control facility of one or more voice commands pertaining to said second user interface through using the above speech recognition data, and forwarding associated recognition information to said second device;
operating said second device as governed by such associated recognition information.

2. A method as claimed in claim 1, wherein said loading provides both user interface information and speech recognition information.

3. A method as claimed in claim 1, wherein said loading is downloading effected in a HAVi context.

4. A multi-device consumer electronics system arranged for implementing a method as claimed in claim 1 and comprising a first device having a first user interface including a voice control facility fed by voice pickup means, and a second device functionally interconnected with said first device,
said system being characterized by comprising:
interconnecting means for interconnecting said first and second devices through a user control level interconnection;
loading means for loading speech recognition data relevant to a second user interface pertinent to said second device, from said second device into the voice control facility of said first device;
recognizing means for recognizing by said voice control facility of one or more voice commands pertaining to said second user interface through using the above speech recognition data, and forwarding associated recognition information to said second device;
and operating means for operating said second device as governed by such associated recognition information.

5. A master device arranged for use as said first device in a system as claimed in claim 4, and comprising a first user interface including a voice control facility fed by voice pickup means, interconnection means for interconnecting to a second device through a user control level interconnection, receive means for receiving speech recognition data relevant to a second user interface pertinent to the second device into its voice control facility, and recognizing means for recognizing by said voice control facility of one or more voice commands pertaining to said second user interface through using the above speech recognition data, and forwarding means for forwarding associated recognition information to said second device.

6. A slave device arranged for use as said second device in a system as claimed in claim 4, and comprising interconnection means for interconnecting to a first user device through a user control interconnection, load means for loading speech recognition data relevant to a second user interface pertinent to said second device, from said second device into the voice control facility of said first device, receiving means for receiving recognition information pertaining to said second user interface from from said voice control facility of the first device, and operating means for operating said second device as governed by such received recognition information.
